(19) United States
(12) Patent Application Publication
(10) Pub. No.: US 2022/0108379 A1
(43) Pub. Date: Apr. 7, 2022

(54) ELECTRONIC APPARATUS AND CONTROL METHOD THEREFOR

(71) Applicant: SAMSUNG ELECTRONICS CO., LTD., Suwon-si (KR)

(72) Inventors: Taeho KIL, Suwon-si (KR); Kyungsu KIM, Suwon-si (KR); Sungjin KIM, Suwon-si (KR); Chanhee JO, Suwon-si (KR); Saemi CHOI, Suwon-si (KR); Hyunsoo CHOI, Suwon-si (KR)

(73) Assignee: SAMSUNG ELECTRONICS CO., LTD., Suwon-si (KR)

(21) Appl. No.: 17/552,557

(22) Filed: Dec. 16, 2021

Related U.S. Application Data
(63) Continuation of application No. PCT/KR2020/010693, filed on Aug. 12, 2020.

(30) Foreign Application Priority Data
Nov. 5, 2019 (KR) 10-2019-0140515

(51) Int. Cl. G06Q 30/06; G06N 20/00

(52) U.S. Cl. CPC G06Q 30/0635; G06N 20/00

(57) ABSTRACT

An electronic device and method are provided. The electronic device includes a memory storing at least one instruction, and a processor configured to execute the at least one instruction to: obtain a target keyword and a purpose keyword from user input data; obtain a plurality of pieces of identification information on each of a plurality of purchase products based on the target keyword and the purpose keyword; and obtain a purchase product list by changing at least one piece of identification information among the plurality of pieces of identification information based on information related to a user.

### CROSS REFERENCE TO RELATED APPLICATION(S)

This application is a by-pass continuation of International Application No. PCT/KR2020/010693, filed on Aug. 12, 2020, in the Korean Intellectual Property Receiving Office, which claims the benefit of Korean Application No. 10-2019-0140515, filed on Nov. 5, 2019, in the Korean Intellectual Property Office, the disclosures of which are incorporated herein by reference in their entireties.

### BACKGROUND

### 1. Field

The disclosure relates to an electronic device and a method for controlling the same, and more particularly to an electronic device which provides shopping information based on user input data and a method for controlling the same.

### 2. Description of Related Art

There may be provided a service providing method for aggregating purchase products input online by a user and generating one shopping list. The shopping list providing service may guide a shopping list, a shopping course, a stock situation, and the like by aggregating information on a plurality of purchase products desired to be purchased by a user through a service providing device.

In a case of receiving a shopping list, the user may conveniently remember a large number of products that the user desires to purchase, and if the user moves through the shopping course, shopping time may be reduced.

In recent years, various service providing methods in relation to shopping are proposed. However, there is a problem that a product is searched with respect to a text based on an input of a user on a server for providing the service. In a case where the search is performed with respect to the text itself, if the product corresponding to the text is not searched, it is difficult to provide result products to the user. In addition, if the text input by the user is not a product, it is difficult to provide a desired result to the user.

For example, it is assumed that the user inputs ingredients for curry. The user may desire to search for ingredients necessary for cooking the curry, rather than a product of cooked curry. However, there is a problem that the service providing device of the related art merely searches for the corresponding product by using text information on the ingredients for curry, but does not search for ingredients necessary for cooking the curry.

Further, there may be a problem that user information is not reflected when providing a plurality of products to the user based on user input data. For example, it is assumed that the user is allergic to a specific food. In a normal search, the specific food causing allergy may not be excluded, and the user may purchase the specific food by mistake.

### SUMMARY

Provided are an electronic device which grasps a user's intent and provides shopping information corresponding to the user's intent, and a method for controlling the same.

In accordance with an aspect of the disclosure, there is provided an electronic device including a memory storing at least one instruction; and a processor configured to execute the at least one instruction to: obtain a target keyword and a purpose keyword from user input data; obtain a plurality of pieces of identification information on each of a plurality of purchase products based on the target keyword and the purpose keyword; and obtain a purchase product list by changing at least one piece of identification information among the plurality of pieces of identification information based on information related to a user.

The processor may be further configured to execute the at least one instruction to obtain the purchase product list by replacing the at least one piece of identification information among the plurality of pieces of identification information with identification information corresponding to another purchase product based on the information related to the user.

The processor may be further configured to execute the at least one instruction to obtain the purchase product list including identification information obtained by excluding the at least one piece of identification information from the plurality of pieces of identification information based on the information related to the user.

The information related to the user may include at least one of nationality, age, gender, purchase history, or preferred seller information of the user.

The processor may be further configured to execute the at least one instruction to: based on the target keyword being a name of a food and the purpose keyword being a keyword related to cooking, obtain identification information on at least one ingredient related to cooking the food; and obtain a changed purchase product list by changing at least one piece of identification information among the obtained identification information on the at least one ingredient based on the information related to the user, wherein the information related to the user may include at least one of nationality, age, gender, purchase history, preferred seller information, allergy information, or taste information of the user.

The processor may be further configured to execute the at least one instruction to obtain the target keyword and the purpose keyword from the user input data by using an artificial intelligence model, wherein the artificial intelligence model is trained to obtain keywords related to a product purchase from input data.

The electronic device may further include a display, wherein the processor may be further configured to execute the at least one instruction to: control the display to display the purchase product list; change identification information corresponding to at least one product included in the purchase product list based on the user input data; and control the display to display a changed purchase product list obtained based on the changed identification information.

The user input data may include at least one of text data, image data, or voice data.

The processor may be further configured to execute the at least one instruction to: identify a language corresponding to text information obtained from the user input data; and obtain the plurality of pieces of identification information on each of the plurality of purchase products based on the identified language.

The processor may be further configured to execute the at least one instruction to: determine a purchase order of each purchase product included in the purchase product list based on location information in a store of each purchase product included in the purchase product list; and change the purchase product list based on the determined purchase order.

In accordance with an aspect of the disclosure, there is provided a method for controlling an electronic device storing at least one instruction, the method including: obtaining a target keyword and a purpose keyword from user input data; obtaining a plurality of pieces of identification information on each of a plurality of purchase products based on the target keyword and the purpose keyword; and obtaining a purchase product list by changing at least one piece of identification information among the plurality of pieces of identification information based on information related to a user.

The obtaining the purchase product list may include obtaining the purchase product list by replacing the at least one piece of identification information among the plurality of pieces of identification information with identification information corresponding to another purchase product based on the information related to the user.

The obtaining the purchase product list may include obtaining the purchase product list including identification information obtained by excluding the at least one piece of identification information from the plurality of pieces of identification information based on the information related to the user.

The information related to the user may include at least one of nationality, age, gender, purchase history, or preferred seller information of the user.

The obtaining the plurality of pieces of identification information may include, based on the target keyword being a name of a food and the purpose keyword being a keyword related to cooking, obtaining identification information on at least one ingredient related to cooking the food, wherein the obtaining the purchase product list may include obtaining a changed purchase product list by changing at least one piece of identification information among the obtained identification information on at least one ingredient based on the information related to the user, and wherein the information related to the user may include at least one of nationality, age, gender, purchase history, preferred seller information, allergy information, or taste information of the user.

### BRIEF DESCRIPTION OF THE DRAWINGS

The above and other aspects, features, and advantages of certain embodiments of the present disclosure will be more apparent from the following description taken in conjunction with the accompanying drawings, in which:

FIG. 1 is a block diagram illustrating an electronic device according to an embodiment;

FIG. 2 is a block diagram illustrating a configuration of an electronic device according to an embodiment;

FIG. 3 is a flowchart illustrating a method for controlling the electronic device according to an embodiment;

FIG. 4 is a flowchart illustrating an operation of recognizing user input data according to an embodiment;

FIG. 5 is a diagram illustrating a text automatic conversion operation according to an embodiment;

FIG. 6 is a flowchart illustrating an operation of recognizing user input data according to another embodiment;

FIG. 7 is a diagram illustrating an operation of providing recommendation words according to an embodiment;

FIG. 8 is a flowchart illustrating a method for identifying a purchase product by considering language information according to an embodiment;

FIG. 9 is a diagram illustrating an embodiment of FIG. 8;

FIG. 10 is a diagram illustrating another embodiment of FIG. 8;

FIG. 11 is a flowchart illustrating a method for identifying a purchase product based on a target keyword and a purpose keyword according to an embodiment;

FIG. 12 is a diagram illustrating an embodiment of FIG. 11;

FIG. 13 is a diagram illustrating another embodiment of FIG. 11;

FIG. 14 is a diagram illustrating an embodiment of identifying a purchase product by considering user information;

FIG. 15 is a diagram illustrating another embodiment of identifying a purchase product by considering user information;

FIG. 16 is a diagram illustrating still another embodiment of identifying a purchase product by considering user information;

FIG. 17 is a diagram illustrating an embodiment of identifying a purchase product by considering various keywords;

FIG. 18 is a diagram illustrating an operation of calculating a weight limit by using weight information according to an embodiment;

FIG. 19 is a diagram illustrating an operation of determining a packing method by using weight information; and

FIG. 20 is a flowchart illustrating a method for controlling the electronic device according to another embodiment.

### DETAILED DESCRIPTION

Hereinafter, embodiments of the disclosure will be described in detail with reference to the accompanying drawings.

The terms used in embodiments of the disclosure have been selected as widely used general terms as possible in consideration of functions in the disclosure, but these may vary in accordance with the intention of those skilled in the art, the precedent, the emergence of new technologies and the like. In addition, in a certain case, there may also be an arbitrarily selected term, in which case the meaning will be described in the description of the disclosure. Therefore, the terms used in the disclosure should be defined based on the meanings of the terms themselves and the contents throughout the disclosure, rather than the simple names of the terms.

In this disclosure, the terms such as “comprise”, “may comprise”, “include”, “may include”, “consist of”, or “may consist of” are used herein to designate a presence of corresponding features (e.g., constituent elements such as number, function, operation, or part), and not to preclude a presence of additional features.

It should be understood that expressions such as “at least one of A or B” and “at least one of A and B” mean any one of “only A”, “only B”, or “both A and B”.

The expressions “first,” “second” and the like used in the disclosure may denote various elements, regardless of order and/or importance, and may be used to distinguish one element from another, and does not limit the elements.

If it is described that a certain element (e.g., first element) is “operatively or communicatively coupled with/to” or is “connected to” another element (e.g., second element), it should be understood that the certain element may be connected to the other element directly or through still another element (e.g., third element).

In the disclosure, unless otherwise defined specifically, a singular expression may encompass a plural expression. It is to be understood that the terms such as “comprise” or “consist of” are used herein to designate a presence of characteristic, number, step, operation, element, part, or a combination thereof, and not to preclude a presence or a possibility of adding one or more of other characteristics, numbers, steps, operations, elements, parts or a combination thereof.

A term such as “module” or a “unit” in the disclosure may perform at least one function or operation, and may be implemented as hardware, software, or a combination of hardware and software. Further, except for when each of a plurality of “modules”, “units”, and the like needs to be realized in an individual hardware, the components may be integrated in at least one module and be implemented in at least one processor.

In this disclosure, a term “user” may refer to a person using an electronic device or a device using an electronic device (e.g., an artificial intelligence electronic device).

Hereinafter, an embodiment of the disclosure will be described in more detail with reference to the accompanying drawings.

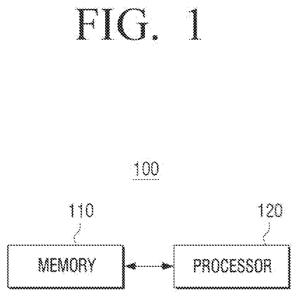

FIG. 1 is a block diagram illustrating an electronic device according to an embodiment.

Referring to FIG. 1, an electronic device 100 may be configured with a memory 110 and a processor 120.

The electronic device according to various embodiments of the disclosure may include at least one of, for example, a smartphone, a tablet personal computer (PC), a mobile phone, a desktop PC, a laptop PC, a personal digital assistant (PDA), a portable multimedia player (PMP), and an MP3 player. In some embodiments, the electronic device 100 may include at least one of, for example, a television, a digital video disk (DVD) player, and a media box (e.g., SAMSUNG HOMESYNC™, APPLE TV™, or GOOGLE TV™).

The memory 110 may be implemented as an internal memory such as a read-only memory (ROM) (e.g., electrically erasable programmable ROM (EEPROM)), a random access memory (RAM), or the like included in the processor 120 or may be implemented as a memory separated from the processor 120. In such a case, the memory 110 may be implemented in a form of a memory embedded in the electronic device 100 or implemented in a form of a memory detachable from the electronic device 100 according to data storage purpose. For example, data for operating the electronic device 100 may be stored in a memory embedded in the electronic device 100, and data for an extended function of the electronic device 100 may be stored in a memory detachable from the electronic device 100.

The memory embedded in the electronic device 100 may be implemented as at least one of a volatile memory (e.g., a dynamic RAM (DRAM), a static RAM (SRAM), a synchronous dynamic RAM (SDRAM), or the like), a non-volatile memory (e.g., a one-time programmable ROM (OTPROM), a programmable ROM (PROM), an erasable and programmable ROM (EPROM), an electrically erasable and programmable ROM (EEPROM), a mask ROM, a flash ROM, a flash memory (e.g., a NAND flash or a NOR flash), a hard drive or a solid state drive (SSD), and the like, and the memory detachable from the electronic apparatus 100 may be implemented as a memory card (e.g., a compact flash (CF), secure digital (SD), a micro secure digital (Micro-SD), a mini secure digital (Mini-SD), extreme digital (xD), a multi-media card (MMC), or the like), an external memory connectable to a universal serial bus (USB) port (e.g., a USB memory), and the like.

The memory 110 may store at least one instruction. The processor 120 may perform various operations based on the instruction stored in the memory 110.

The processor 120 may perform a general control operation of the electronic device 100. Specifically, the processor 120 may perform a function of controlling general operations of the electronic device 100.

The processor 120 may be implemented as a digital signal processor, a microprocessor, a graphics processing unit (GPU), an artificial intelligence (AI) processor, and a time controller (TCON) for processing digital image signals. However, there is no limitation thereto, and the processor may include one or more of a central processing unit (CPU), a microcontroller unit (MCU), a microprocessing unit (MPU), a controller, an application processor (AP), or a communication processor (CP), and an ARM processor or may be defined as the corresponding term. In addition, the processor 120 may be implemented as System on Chip (SoC) or large scale integration (LSI) including the processing algorithm or may be implemented in form of an application specific integrated circuit (ASIC) or a field programmable gate array (FPGA). The processor 120 may perform various functions by executing computer executable instructions stored in the memory 110.

By executing at least one instruction, the processor 120 may obtain a target keyword and a purpose keyword from input data of a user, obtain a plurality of pieces of identification information on each of a plurality of purchase products based on the target keyword and the purpose keyword, and obtain a purchase product list by changing at least one piece of identification information among the plurality of pieces of identification information based on information related to the user.

The processor 120 may receive user input data. The user input data may refer to data input by the user for searching, and the purpose of the searching may be shopping, product order, and shopping list generation. The electronic device 100 may receive user input data via an input and output interface included in the electronic device 100.

The user input data may include at least one of text data, image data, or voice data.

If the user input data is the text data, the processor 120 may obtain identification information on a purchase product included in the text data by performing analysis based on the text data itself.

If the user input data is the image data, the processor 120 may obtain the identification information on the purchase product included in the image data by analyzing the image data. Here, for an image analysis operation, the processor 120 may use an artificial intelligence module related to image analysis.

If the identification information on the purchase product is the voice data, the processor 120 may obtain the identification information on the purchase product by performing a voice recognition operation for analyzing the voice data. For the voice recognition operation, the processor 120 may use an artificial intelligence module related to voice recognition.

The processor 120 may obtain the target keyword and the purpose keyword from the user input data by using the artificial intelligence model, and the artificial intelligence model may be trained to obtain a keyword related to product purchase from the input data.

The processor 120 may obtain the identification information on the purchase product information by analyzing the user input data. The processor 120 may convert the user input data into text information. The processor 120 may identify the purchase product included in the user input data based on the converted text information. In addition, the processor 120 may obtain the identification information related to the identified purchase product. Here, the converted text information may be referred to as text information corresponding to the user input data.

The identification information related to the purchase product may refer to information on at least one product corresponding to the user input data. The identification information on the purchase product may include at least one of a product name, a brand name, a manufacturer, an expiration date, a production date, an amount in stock, and an identification number.

The processor 120 may limit a domain to increase a recognition rate in a process of converting the user input data to the text information. The domain may refer to a data group used for searching for a result regarding the input data. The processor 120 may perform an analysis operation by limiting the domain related to the product purchase. In a method for performing the analysis operation by limiting a specific domain, it is possible to reduce analysis time and increase a recognition rate with respect to input data related to the product purchase, compared to a case of performing the analysis operation based on domains related to various subjects. For example, it is assumed that the user input data is erroneously input as “sansung TV”. Here, if the domain is limited to the domain related to the product purchase, the processor 120 may rapidly analyze as “samsung TV”, rather than “sansung TV”. In the analysis operation in various domains, search results for “sansung” in various fields are obtained, but in the analysis operation in a domain limited to the domain related to the product purchase, the processor may rapidly determine that “sansung” is erroneously input.

In a normal search engine, if a specific domain is limited instead of domains related to various subjects, a recognition rate may decrease. However, the electronic device 100 aims in obtaining a purchase list, and accordingly, the user input data related to the product purchase are received in many cases. If the user input data not related to the product purchase is received, the recognition rate may decrease. However, since the electronic device 100 according to the disclosure provides a search function related to the product purchase, the decrease of the recognition rate regarding the user input data not related to the product purchase may not directly relate to the performance of the electronic device 100. Because it may be preferable not to provide the result regarding the erroneous user input data.

The processor 120 may identify language information corresponding to text information obtained from the user input data and obtain identification information on each of a plurality of purchase products based on the identified language information.

Here, the processor 120 may determine in which language at least one of a text, an image, or a voice included in the user input data is generated. The processor 120 may obtain the identification information on the purchase product based on the language information corresponding to the user input data. The processor 120 may obtain the identification information on different purchase products based on the language information. For example, if the text information of the user input data is curry in Korean, the processor 120 may obtain identification information on Korean curry. If the text information of the user input data is curry in Indian language, the processor 120 may obtain identification information on Indian curry.

When the language information corresponding to the user input data is considered, a probability that a purchase product desired by the user is provided as a result may increase. Accordingly, satisfaction of the user may increase.

The processor 120 may determine whether the user input data is correctly input. The determination whether the user input data is correctly input may refer to determination whether a purchase product different from the user's intent is identified. The reasons that the user input data is not correctly recognized unlike the user's intent may be a typographic error, incorrect pronunciation, low-quality image, and the like.

The processor 120 may convert the user input data into text data and perform analysis of reliability of the converted text data. The reliability analysis may be performed based on at least one of determination of a completed word of the entire text and comparison of pre-stored product words. If the reliability analysis is performed based on the artificial intelligence model, a result value may be obtained along with a probability value. For example, if A data is received, a probability that the result value is A may be 90% and a probability that the result value is AB may be 10%. Here, if a highest probability value of the obtained probability values is equal to or less than a threshold value, the processor 120 may determine that the user input data is erroneously input or determine that the user input data is not correctly recognized.

If it is identified that the user input data is not correctly recognized (erroneous recognition), the processor 120 may change the text data corresponding to the user input data.

According to an embodiment, if the processor 120 determines that the user input data is erroneously input, the processor 120 may automatically change the text information corresponding to the user input data into a predetermined word. For example, if a word “sansung” is input, it may be automatically changed to “Samsung”.

According to another embodiment, if it is determined that the user input data is erroneously input, the processor 120 may provide a recommendation word information. The processor 120 may provide recommendation word information similar to the erroneously input user input data to the user. Here, the recommendation word information may be obtained based on the text information corresponding to the user input data. For example, it is assumed that “melom” is input. If the purchase product information corresponding to “melom” is not recognized, the processor 120 may provide a user interface (UI) for guiding to select at least one of “melon”, “watermelon”, and “rock melon” similar to “melom”.

Here, the processor 120 may obtain the recommendation word information based on history information of the products that the user purchased before. For example, if it is identified that the user purchased the watermelon number of times that is equal to or more than a threshold value in the past history, the processor 120 may obtain recommendation word information “watermelon” with respect to the input of “melom”.

According to still another embodiment, if it is identified that the user input data is erroneously input, the processor 120 may guide the user to input data again. Here, the guiding method may be a method for providing a UI or providing a voice notification.

The processor 120 may analyze the user's intent based on the user input data. The analysis of the user's intent may refer to analysis regarding whether the user input data is input to purchase the purchase product itself or input for a specific purpose.

The user input data may include at least one of a target keyword or a purpose keyword. Here, the target keyword may refer to a keyword related to the purchase product. The purpose keyword may refer to a keyword related to an action corresponding to the purchase product. For example, the target keyword may be “curry” and the purpose keyword may be “ingredients”. The purpose keyword may be a pre-stored word and may include at least one of ingredients, preparation, materials, cooking, cooking ingredients, a recipe, cleaning, cleaning equipment, and a cleaning method.

If the user input data includes only the target keyword, the processor 120 may determine that the user orders the product itself. For example, if the user input data is “curry”, the processor 120 may obtain the identification information on the purchase product corresponding to “curry”.

In addition, if the user input data includes the purpose keyword, the processor 120 may determine that the user desires to purchase the purchase product for a specific purpose, rather than ordering the product itself. For example, if the user input data is a “cleaning method”, the processor 120 may obtain identification information on various purchase products related to the cleaning method.

In addition, if the user input data includes both the target keyword and the purpose keyword, the processor 120 may obtain identification information on a plurality of purchase products based on the target keyword and the purpose keyword. Specifically, the processor 120 may identify various purchase products related to an operation of performing the purpose keyword by the target keyword. For example, if the target keyword is “curry” and the purpose keyword is “ingredients”, the processor 120 may analyze ingredients for cooking curry and obtain identification information on a plurality of ingredients (“curry powder”, “potatoes”, “onions”, “carrots”, and “ham”) for cooking the curry. In another example, if the target keyword is “bathroom” and the purpose keyword is “cleaning”, the processor 120 may obtain identification information on a plurality of purchase products for cleaning the bathroom.

If a number of analysis results regarding the user input data is equal to or greater than a threshold value, the processor 120 may make the user determine details, in order to limit to a specific product group. The processor 120 may display a UI on a display, in order to make the user determine the details. The UI according to an embodiment may include category information. Here, the category may refer to a word that can be grouped in a specific classification. The category may be at least one of fruits and vegetables, fishes and meats, frozen foods, snacks, kitchen supplies, bath supplies, drinks, and alcohols. When one category of the plurality of categories is selected by the user, the processor 120 may obtain identification information on a purchase product corresponding to the selected category. A UI according to another embodiment may include manufacturer information. When one manufacturer of the plurality of manufacturers is selected by the user, the processor 120 may obtain identification information on a purchase product based on the selected manufacturer.

If the number of analysis results regarding the target keyword and the purpose keyword is equal to or more than a threshold value, the processor 120 may display a UI on a display 160 to make the user determine the details, in order to reduce the number of the analysis results. The UI according to an embodiment may be a word for specifically limiting the target or the purpose, in order to reduce the number of analysis results regarding the target keyword and the purpose keyword. For example, it is assumed that the user input data is “curry ingredients”. Here, various curry ingredients may be provided according to which curry is to be cooked, and the number of analysis results may be equal to or more than the threshold value. For example, there may be various types of curry such as Korean curry, Indian curry, and Japanese curry, and the ingredients may be different. If the number of analysis results regarding the “curry ingredients” is equal to or more than the threshold value, the processor 120 may provide a UI for guiding to select one type of curry of Korean curry, Indian curry, and Japanese curry.

The processor 120 may change the obtained identification information on the purchase product based on the information related to the user.

Here, the information related to the user may include at least one of nationality, age, gender, purchase history, or preferred seller information of the user.

The processor 120 may obtain the identification information on the plurality of purchase products by using the target keyword and the purpose keyword. Here, the processor 120 may change pieces of the obtained identification information on the plurality of purchase products based on the information related to the user information. For example, if the user input data is “curry ingredients” and the nationality of the user is Korean, the processor 120 may obtain identification information on ingredients for cooking Korean curry.

In addition, if the target keyword is a food name and the purpose keyword is a keyword related to a cooking action, the processor 120 may obtain identification information on each of ingredients necessary for cooking food, and obtain a purchase product list by changing at least one piece of identification information among the plurality of pieces of identification information based on the information related to the user, and the information related to the user may include at least one of nationality, age, gender, purchase history, preferred seller information, allergy information, or taste information of the user.

In addition, the processor 120 may change identification information obtained in advance based on the user information. For example, it is assumed that the user is allergic to carrots. It is assumed that the user input data is “curry ingredients” and identification information on “curry powder, potatoes, onions, carrots, and ham” are obtained as the analysis result. The processor 120 may identify that the user is allergic to carrots and change the purchase product regarding carrots.

In addition, the processor 120 may obtain a purchase product list by replacing the at least one piece of identification information among the plurality of pieces of identification information based on the information related to the user with the identification information corresponding to another purchase product. In the assumption that the user is allergic to carrots, the processor 120 may change carrot to another item. For example, the processor 120 may change the identification information on carrots to identification information on mushrooms. As a result, the processor 120 may obtain identification information on “curry powder, potatoes, onions, mushrooms, and ham”, and generate a purchase product list based on the obtained identification information.

In addition, the processor 120 may obtain a purchase product list including identification information except for the at least one piece of identification information among the plurality of pieces of identification information based on the information related to the user. In the assumption that the user is allergic to carrots, the processor 120 may remove the identification information on carrots. As a result, the processor 120 may obtain the identification information on “curry powder, potatoes, onions, and ham”, and generate a purchase product list based on the obtained identification information.

In addition, in a case of changing the identification information based on the information related to the user, the processor 120 according to an embodiment may change the identification information automatically. The processor 120 may automatically change the identification information obtained in advance, based on the information related to the user stored in the memory 110.

In addition, in a case of changing the identification information based on the information related to the user, the processor 120 according to an embodiment may provide a UI for changing the identification information to the user. The processor 120 may confirm the user's intent again through the UI.

The processor 120 may display a UI for confirming whether to complete the order based on the obtained identification information on the purchase product. When a final confirmation of the user is received, the processor 120 may generate the purchase product list based on the confirmed identification information and display the generated purchase product list.

In addition, the processor 120 may change the obtained identification information in any one step of a user input data input step, a final confirmation step, a purchase product list generation step, or a step after the purchase product list generation. Here, the change may refer to at least one of replacement, exclusion, and addition. For example, based on the input of the user, the processor 120 may replace or exclude the identification information on the purchase product obtained in advance, and add identification information on a new purchase product.

In addition, the processor 120 may control the display to display the purchase product list, change the identification information corresponding to at least one product included in the purchase product list based on the user input, and control the display to display the purchase product list obtained based on the changed identification information.

The processor 120 may obtain a shopping order based on the obtained purchase product list. In order to determine the shopping order, the processor 120 may consider store information, stock information, and purchase product information.

Herein, the store information may include at least one of store location information, arranged location information of purchase products in the store, or operating hour information.

Here, the stock information may refer to information on a stock situation of the purchase products.

Here, the purchase product information may include at least one of storage temperature information, weight information, volume information, and deformation possibility information.

The storage temperature information may refer to an appropriate storage temperature of the purchase product, and the purchase product may be divided into a product stored at room temperature, a product stored refrigerated, or a product stored frozen according to the storage temperature information. The processor 120 may determine the shopping order according to the storage temperature information. Specifically, the processor 120 may determine that a purchase product having low storage temperature information to have relatively low priority. This is because, if frozen food having a low storage temperature (e.g., ice cream) is put in a basket first, it may melt.

The weight information may include an absolute weight value of the purchase product. The processor 120 may determine that the purchase product having a weight value equal to or more than a threshold value to have relatively low priority. Because, if a heavy purchase product is put in a basket first, the user's arm may hurt or it may be not appropriate for shopping for other products. However, if the user uses a movable shopping cart, the weight information may be ignored.

The volume information may include an absolute volume value of the purchase product. The processor 120 may determine that the purchase product having a volume value equal to or more than a threshold value has relatively low priority. This is because, if an item having a large volume is put in a basket first, it is difficult to choose a large number of purchase products.

The deformation possibility information may include information regarding whether the purchase product is a product that is easily deformable. For example, fruits such as bananas or strawberries may be a purchase product that is easily deformable. The processor 120 may determine the purchase product that is easily deformable to have relatively low priority. If the purchase product that is easily deformable is put in a basket first (if it is positioned at the bottom of the shopping cart), it may be deformed by other purchase products to be subsequently put in the basket.

In addition, the processor 120 may provide a shopping list and a movement path based on at least one of the store information, the stock information, and the purchase product information. Here, the movement path may be determined based on a shortest period of time or a shortest movement distance while applying the standard described above.

In addition, the processor 120 may determine a purchase order of each purchase product included in the purchase product list based on location information in a store of each purchase product included in the purchase product list, and change the purchase product list based on the determined purchase order.

In addition, the processor 120 may identify at which location of the store the purchase product is disposed based on the store information. The processor 120 may analyze the purchase order of the purchase products based on the location information in the store of each purchase product. The processor may change an order of a previous purchase product list based on the analyzed purchase order.

The processor 120 may obtain total weight information included in the purchase product list and determine a delivery method or a packing method.

Here, the processor 120 may obtain shopping member information after obtaining the total weight information. The shopping member information may include at least one of genders and ages of members of the shopping and the information of the number of members. A weight limit of the user may be determined based on the shopping member information. For example, a weight limit of a grown woman may be 10 kg and a weight limit of a grown man may be 30 kg. The specific values thereof may be changed according to setting of the user. If the shopping member information indicates one grown woman and three grown men, the total weight limit may be 100 kg.

Here, the processor 120 may compare the shopping member information and the total weight information. Here, if the total weight information included in the purchase product list exceeds the weight limit, the processor 120 may provide a UI for confirming whether there is a separate shipping method (delivery service) or guiding the user to exclude some items.

In addition, the processor 120 may obtain the total weight information and the shopping member information included in the shopping purchase list and determine the packing method. In an example, the processor 120 may divide purchase items into a plurality of boxes (or plastic bags) while dividing the purchase items so that each box has a uniform weight. In another example, the processor 120 may divide the purchase products by considering the weight limit of the user. It is assumed that the shopping member indicates one grown woman and three grown men and the total weight information is 100 kg. The processor 120 may provide positions between products to divide 100 kg of the purchase products into 10 kg, 30 kg, 30 kg, and 30 kg.

The electronic device 100 according to an embodiment may be applied to a movable robot. In an example, the movable robot may receive user input data. In general, the movable robot may include at least one of a keyboard or a microphone. In another example, the movable robot may receive user input data from an external terminal device. In a case of the movable robot, a lock function may be activated by the setting of the user, and if the lock function is activated, it may be set to be unable to change the purchase product list.

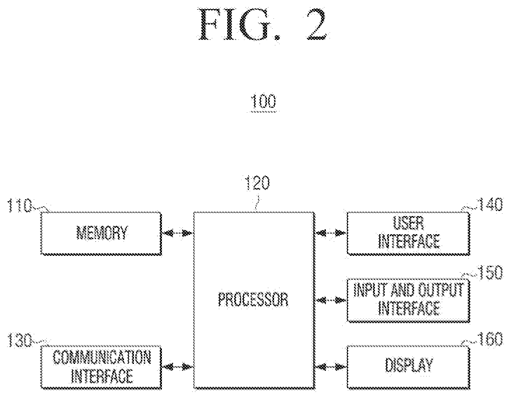

FIG. 2 is a block diagram illustrating a specific configuration of the electronic device of FIG. 1.

Referring to FIG. 2, the electronic device 100 may include the memory 110, the processor 120, a communication interface 130, a user interface 140, an input and output interface 150, and the display 160.

The description of operations of the memory 110 and the processor 120 which are the same as described above will not be repeated.

The processor 120 may generally control the operations of the electronic device 100 by using various programs stored in the memory 110.

Specifically, the processor 120 may include a RAM, a ROM, a main CPU, first to n-th interfaces, and a bus. The RAM, the ROM, the main CPU, and the first to n-th interfaces may be connected to each other via the bus 135. The ROM may store a set of instructions for system booting, and the like. If a turn-on instruction is input to supply power, the main CPU copies the O/S stored in the memory 110 to the RAM and boots the system up by executing the O/S according to the instruction stored in the ROM. When the booting is completed, the main CPU copies various application programs stored in the memory 110 to the RAM and executes various operations by executing the application programs copied to the RAM. The main CPU may execute the booting by using the O/S stored in the memory 110 by accessing the memory 110. The main CPU may execute various operations using various programs, contents, data, and the like stored in the memory 110. The first to n-th interfaces may be connected to the various elements described above. One of the interfaces may be a network interface connected to an external device via a network.

The communication interface 130 may be configured to communicate with various types of external devices according to various types of communication methods. The communication interface 130 may include a Wi-Fi module, a Bluetooth module, an infrared communication module, a wireless communication module, and the like. Each communication module may be implemented as at least one hardware chip.

The Wi-Fi module and the Bluetooth module may communicate by a Wi-Fi method and a Bluetooth method, respectively. In a case of using the Wi-Fi module or the Bluetooth module, various pieces of connection information such as a service set identifier (SSID) or session key may be transmitted or received first to allow the communication connection by using these, and then various pieces of information may be transmitted and received.

The infrared communication module may perform communication according to a technology of infrared communication (Infrared data association (IrDA)) for transmitting data in a close range wirelessly by using infrared rays between visible rays and millimeter waves.

The wireless communication module may include at least one communication chip for performing communication according to various wireless communication standard such as Zigbee, 3rd Generation (3G), 3rd Generation Partnership Project (3GPP), Long Term Evolution (LTE), LTE Advanced (LTE-A), 4th Generation (4G), 5th Generation (5G), and the like, in addition to the above communication method.

In addition, the communication interface 130 may include at least one of wired communication modules for performing communication by using a local area network (LAN) module, an Ethernet module, pair cables, a coaxial cable, an optical fiber cable, and the like.

According to an example, the communication interface 130 may use the same communication module (e.g., Wi-Fi module) to communicate with an external device such as a remote control and an external server.

According to another example, the communication interface 130 may use different communication modules to communicate with an external device such as a remote control and an external server. For example, the communication interface 130 may use at least one of the Ethernet module or the Wi-Fi module to communicate with an external server and use the Bluetooth module to communicate with an external device, such as a remote control. However, this is merely an example, and the communication interface 130 may use at least one communication module among various communication modules when communicating with a plurality of external devices or external servers.

The user interface 140 may be implemented as a device such as a button, a touch pad, a mouse, and a keyboard, and may also be implemented as a touch screen capable of performing the display function and the manipulation input function. The button may be various types of buttons such as a mechanical button, a touch pad, or a wheel formed in any region of a front portion, a side portion, or a rear portion of the appearance of the main body of the electronic device 100.

The input and output interface 150 may be any one interface of a High Definition Multimedia Interface (HDMI), a mobile High-Definition Link (MHL), a Universal Serial Bus (USB), Display Port (DP), Thunderbolt, a Video Graphics Array (VGA) port, an RGB port, D-subminiature (D-SUB), and Digital Visual Interface (DVI).

The input and output interface 150 may input and output at least one of audio and video signals.

According to an implementation example, the input and output interface 150 may include a port for inputting and outputting only audio signals and a port for inputting and outputting only video signals as separate ports, or may be implemented as one port for inputting and outputting both the audio signals and the video signals.

The electronic device 100 may be implemented as a device not including the display and transmit an image signal to a separate display device.

The electronic device 100 may receive a user voice signal from an external device including a microphone. In this case, the received user voice signal may be a digital voice signal or may be an analogue voice signal according to the implementation example. In an example, the electronic device 100 may receive the user voice signal by a wireless communication method such as Bluetooth or Wi-Fi. Here, the external device may be implemented as a remote control device or a smartphone.

The electronic device 100 may transmit the corresponding voice signal to the external server, for voice recognition of the voice signal received from the external device.

In this case, the communication module for communicating with the external device and the external server may be implemented as one module or implemented separately. For example, the electronic device may communicate with the external device by using the Bluetooth module and communicate with the external server by using the Ethernet modem or the Wi-Fi module.

The display 160 may be implemented as various types of display such as a liquid crystal display (LCD), an organic light emitting diode (OLED) display, a plasma display panel (PDP), and the like. The display 160 may also include a driving circuit or a backlight unit which may be implemented in a form of a-silicon (Si) thin film transistor (TFT), a low temperature poly silicon (LTPS) TFT, or an organic TFT (OTFT). The display 160 may be implemented as a touch screen combined with a touch sensor, a flexible display, a 3D display, or the like.

In addition, according to an embodiment of the disclosure, the display 160 may include a bezel for housing a display panel, not only a display panel for outputting an image. Particularly, according to an embodiment of the disclosure, the bezel may include a touch sensor for detecting user interaction.

The electronic device 100 may include a speaker. The speaker may output various alerts or voice messages, in addition to various audio data processed by the input and output interface 150.

The electronic device 100 may further include a microphone. The microphone may be an element for receiving and converting a user's voice or other sounds into audio data.

The microphone may receive the user's voice in an activated state. For example, the microphone may be integrally formed on an upper, front, or side portion of the electronic device 100. The microphone may include various elements such as a microphone which collects the user's voice in an analogue state, an amplification circuit which amplifies the collected user's voice, an analog/digital (A/D) conversion circuit which samples the amplified user's voice and converts the user's voice into a digital signal, a filter circuit which removes noise components from the converted digital signal, and the like.

If the analogue voice signal of the user is received via the microphone, the electronic device 100 may convert the analogue voice signal into a digital voice signal. In this case, the electronic device 100 may perform voice recognition for the digital voice signal by using a voice recognition application. Here, the voice recognition application may be the same as or different from the remote control application described above. When the voice recognition for the digital voice signal is performed, the electronic device 100 may control the electronic device 100 remotely by using the remote control application based on the voice recognition result. However, according to another embodiment, a smartphone may transmit the converted digital voice signal to the electronic device 100 by using at least one of infrared, Wi-Fi, or Bluetooth method. In this case, when the digital voice signal is received from the external device, the electronic device 100 may perform the voice recognition based on the received digital voice signal and perform the control operation based on the voice recognition result.

The electronic device 100 according to an embodiment of the disclosure may transmit the received digital voice signal to the voice recognition server. In this case, the voice recognition server may convert the digital voice signal into text information by using a speech-to-text (STT) function. In this case, the voice recognition server may transmit the text information to another server or an electronic device to perform search corresponding to the text information and may also perform the search directly, in some cases.

The electronic device 100 according to another embodiment of the disclosure may convert the digital voice signal into the text information by applying the speech-to-text (STT) function directly to the digital voice signal and transmit the converted text information to the external server.

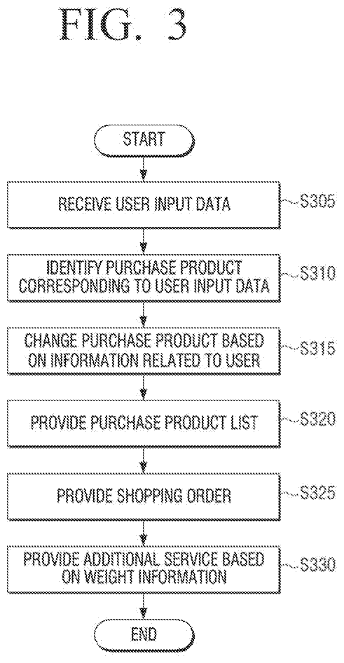

FIG. 3 is a flowchart illustrating a method for controlling the electronic device according to an embodiment.

Referring to FIG. 3, the electronic device 100 may receive user input data (S305). The electronic device 100 may analyze the user input data and identify a purchase product corresponding to the user input data (S310). The electronic device 100 may obtain identification information on the identified purchase product.

The electronic device 100 may change the purchase product based on the information related to the user (S315). Here, the information related to the user may include at least one of nationality, age, gender, purchase history, or preferred seller information of the user. For example, the electronic device 100 may identify a first purchase product based on the user input data and obtain identification information corresponding to the first purchase product. Then, the electronic device 100 may change the identification information corresponding to the first purchase product based on the information related to the user. The change may refer to replacement, removal, addition, and the like.

The electronic device 100 according to an embodiment may replace the purchase product based on the information related to the user. The electronic device 100 may replace the identification information corresponding to the first purchase product with identification information corresponding to a second purchase product based on the information related to the user.

The electronic device 100 according to another embodiment may remove the purchase product based on the information related to the user. The electronic device 100 may remove the identification information corresponding to the first purchase product based on the user input data.

The electronic device 100 according to another embodiment may add a new purchase product based on the information related to the user. The electronic device 100 may add identification information on the second purchase product mapped to the first purchase product based on the information related to the user.

The electronic device 100 may obtain identification information (e.g., a plurality of pieces of identification information) corresponding to at least one purchase product based on the user input data. Here, the identification information may be information corresponding to a plurality of purchase products. The obtained identification information may be changed based on the information related to the user. The electronic device 100 may confirm the purchase products finally. When the purchase products are confirmed, the electronic device 100 may generate a purchase product list based on the confirmed purchase products. The electronic device 100 may provide the generated purchase product list to the user (S320). The providing method to the user may be a method for displaying the purchase product list on the display 160. The electronic device 100 may change the purchase product list based on a user input. The user may remove or add some purchase products from or to the purchase product list.

When the purchase product list is confirmed by the user, the electronic device 100 may obtain the shopping order based on the purchase product list. The electronic device 100 may obtain the shopping order of the plurality of purchase products included in the purchase product list. The electronic device 100 may provide the shopping order based on the purchase product list to the user (S325). The method for providing the shopping order may be a method for displaying the shopping order on the display.

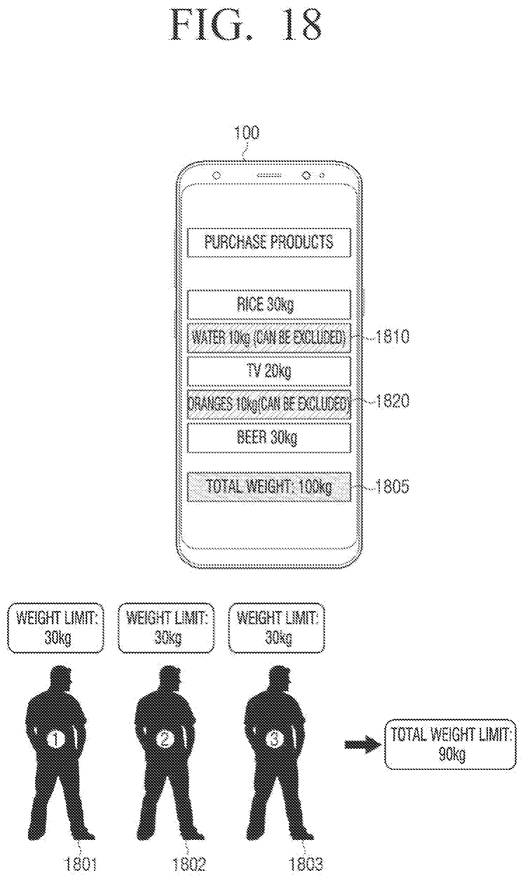

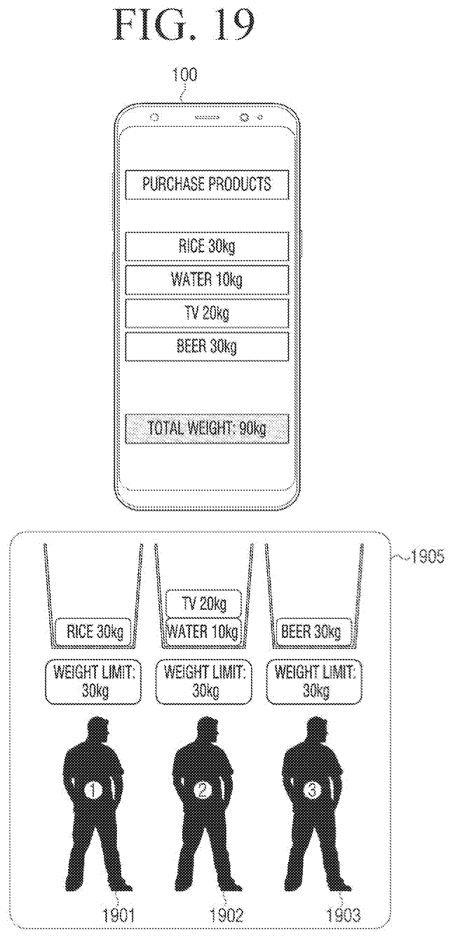

The electronic device 100 may obtain the weight information based on the purchase product list. Specifically, the electronic device may obtain the weight information of each of the purchase products included in the purchase product list. The electronic device may provide an additional service based on the obtained weight information (S330). Here, the additional service may provide a service of excluding some purchase products by considering the weight limit of the user or a service of providing a method for packing finally purchased products. The additional service will be described below in detail with reference to FIGS. 18 and 19.

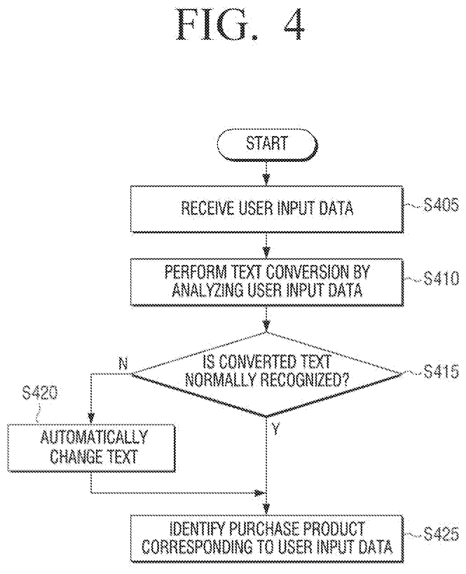

FIG. 4 is a flowchart illustrating an operation of recognizing user input data according to an embodiment.

Referring to FIG. 4, the electronic device 100 may receive the user input data (S405). The electronic device 100 may analyze the received user input data and convert the user input data into a text (or text data) (S410). The electronic device 100 may determine whether the converted text is normally recognized (S415). A determination reference regarding whether the converted text is normally recognized may be whether a result value is obtained based on the converted text. Specifically, if a search result is obtained based on the converted text, it may be considered that the text is normally recognized, and if the search result is not obtained based on the converted text, it may be considered that the text is not normally recognized.

If the converted text is not normally recognized, the electronic device 100 may automatically change the converted text into a predetermined word corresponding to the converted text (S420). The converted text that is not normally recognized may be an erroneously input word, and the memory may store predetermined words mapped to the erroneous word described above.

When the converted text is normally recognized, the electronic device 100 may identify the purchase product corresponding to the user input data (S425).

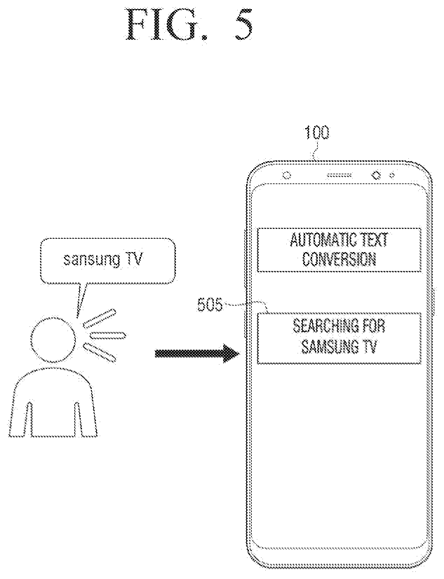

FIG. 5 is a diagram illustrating a text automatic conversion operation according to an embodiment.

Referring to FIG. 5, the electronic device 100 may obtain text data based on the user input data input by the user. The electronic device 100 may correspond to a device which provides a service related to the purchase product, and may perform an operation of identifying the purchase product corresponding to the user input data. Accordingly, the electronic device 100 may identify the purchase product corresponding to the user input data. The electronic device 100 may determine whether the obtained text data is normally recognized, in order to identify the purchase product corresponding to the user input data. The determination reference of normal recognition may be whether the purchase product is identified based on the obtained text data. If the purchase product is not identified based on the user input data, the electronic device 100 may determine that the user input data is not normally recognized.

If the purchase product corresponding to the user input data is not identified, the electronic device 100 may determine that the user input data is erroneously input. The electronic device 100 may automatically convert the text corresponding to the user input data. Here, the data to be automatically converted may be stored in the memory 110 or the like in advance.

Referring to FIG. 5, it is assumed that the user utters “sansung TV”. The electronic device 100 may receive the user input data (“sansung TV”) via the microphone attached to the electronic device 100. In addition, the electronic device 100 may change the received user input data (voice data) into the text data (“sansung TV”). The electronic device 100 may identify whether there is a purchase product corresponding to the text data (“sansung TV”). Here, it is assumed that the purchase product corresponding to the sansung TV is not searched. The electronic device 100 may determine that the text data (“sansung TV”) is erroneously input. The electronic device 100 may change the text data (“sansung TV”) determined to be erroneously input to a predetermined word (“samsung TV”) automatically. The predetermined word (“samsung TV”) herein may be a word previously mapped to the specific word (“sansung TV”). Specifically, the electronic device 100 may control the memory 110 to map and store the words erroneously input by users to correctly input words. As a result, the electronic device 100 may change the text data (“sansung TV”) to the predetermined word (“samsung TV”) and identify a purchase product based on the changed word (“samsung TV”). In addition, the electronic device 100 may provide a notification notifying that the purchase product is identified based on the change word through a UI 505.

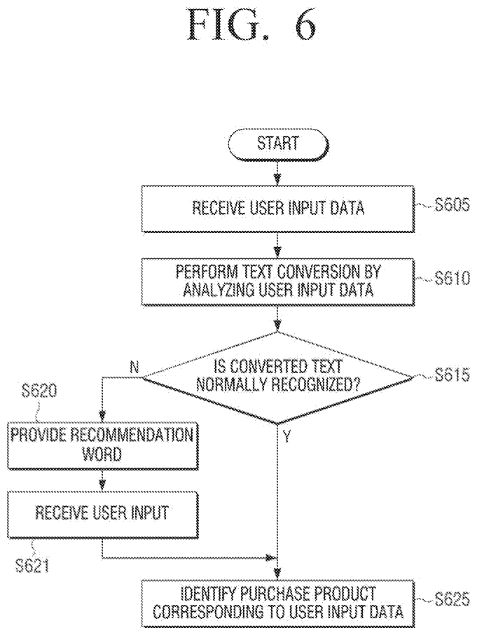

FIG. 6 is a flowchart illustrating an operation of recognizing user input data according to another embodiment.

Referring to FIG. 6, the electronic device 100 may receive user input data (S605). In addition, the electronic device 100 may perform the text conversion operation by analyzing the user input data (S610). The electronic device 100 may determine whether the converted text is normally recognized (S615). Here, the steps S605, S610, and S615 may correspond to the steps S405, S410, and S415 of FIG. 4, respectively, and the overlapped description will not be repeated.

If the converted text is not normally recognized, the electronic device 100 may provide a recommendation word to the user based on the converted text (S620). A specific word may be selected from a plurality of recommendation words provided to the user. The electronic device 100 may receive a user input to receive selection of the specific word (S621). The electronic device 100 may obtain at least one specific word selected by the user input from the at least one recommendation word. In addition, the electronic device 100 may identify a purchase product based on the at least one obtained specific word (S625). As a result, the electronic device 100 may identify a purchase product based on a word (selected by the user) corresponding to the user input data.

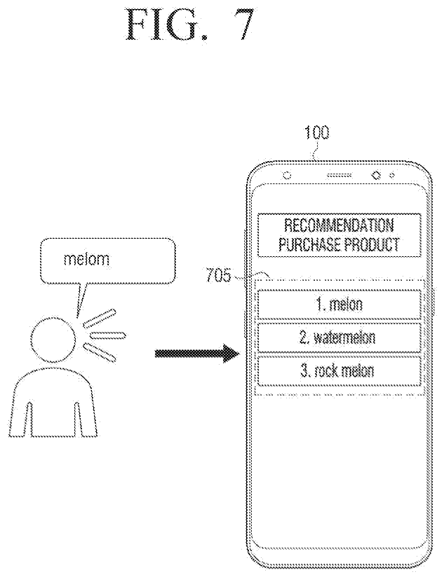

FIG. 7 is a diagram illustrating an operation of providing recommendation words according to an embodiment.

Referring to FIG. 7, if the purchase product corresponding to the user input data is not identified, the electronic device 100 may provide a recommendation word corresponding to the user input data. The electronic device 100 may display the recommendation word through a UI 705, in order to receive selection of at least one recommendation word from the user.

It is assumed that the user input data is (“melom”). If a purchase product corresponding to the user input data (“melom”) is not identified, the electronic device 100 may display at least one recommendation word (“melon”, “watermelon”, and “rock melon”) corresponding to the user input data (“melom”) on the display 160 to provide it to the user. The electronic device 100 may receive a specific recommendation word selected by the user input. The electronic device 100 may identify the purchase product based on the specific recommendation word selected by the user input.

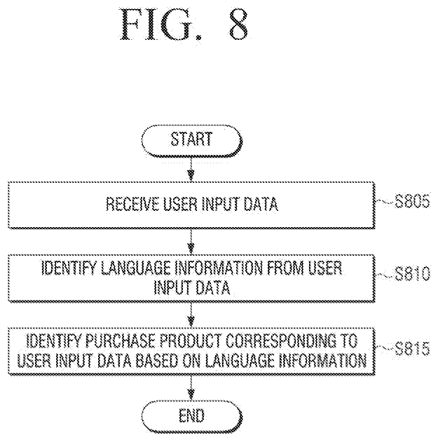

FIG. 8 is a flowchart illustrating a method for identifying a purchase product by considering language information according to an embodiment.

Referring to FIG. 8, the electronic device 100 may receive user input data (S805). The electronic device 100 may identify language information from the user input data (S810). Here, the language information may refer to a language of a specific country or a language in a specific cultural area. In addition, the language information may include at least one of a voice language or a written language. If the user input data is voice data, the electronic device 100 may analyze the user input data and determine in which language the user's voice is uttered. In addition, if the user input data is data input by typing or data obtained by an image analysis technology, the electronic device may identify which language the corresponding text corresponds to. The electronic device 100 may identify the purchase product corresponding to the user input data based on the identified language (S815).

For example, the electronic device 100 may determine that the language information corresponding to the user input data is Korean. Here, the electronic device 100 may provide purchase products related to mainly Korea as a result. If the language information corresponding to the user input data is French, the electronic device 100 may provide purchase products related to mainly France as a result.

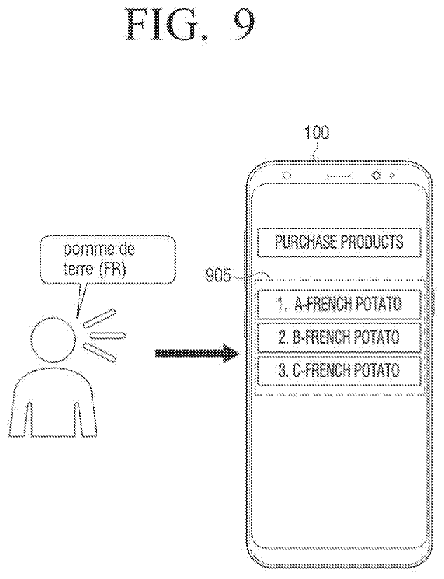

FIG. 9 is a diagram illustrating an embodiment of FIG. 8.

Referring to FIG. 9, the electronic device 100 may identify language information by analyzing user input data (“pomme de terre”). The electronic device 100 may determine that “pomme de terre” corresponds to French. “pomme de terre” in French means potato. The electronic device 100 may identify the purchase product based on the user input data (“pomme de terre”) based on the language information (French). The electronic device 100 may provide a purchase product result 905 related to France while providing the result regarding the potato to the user. Specifically, based on the user input data (“pomme de terre”) and the language information (French), the electronic device 100 may display purchase products corresponding to the potato (A-French potato, B-French potato, and C-French potato).

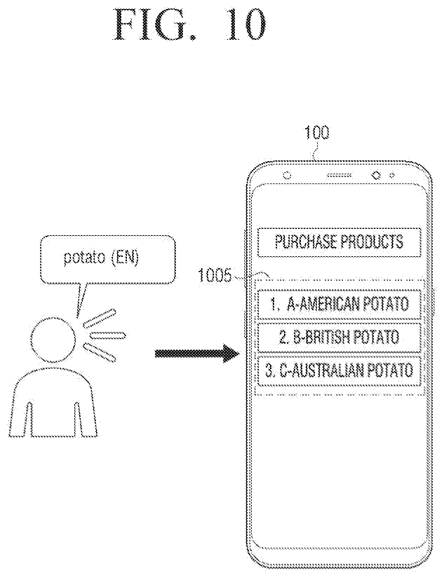

FIG. 10 is a diagram illustrating another embodiment of FIG. 8.

Referring to FIG. 10, the electronic device 100 may identify language information by analyzing user input data (“potato”). The electronic device 100 may determine that the “potato” corresponds to English. Accordingly, the electronic device 100 may identify the language information as English. The electronic device may identify a purchase product based on the identified language information (English). The electronic device 100 may provide a purchase product result 1005 related to English-speaking countries while providing the result regarding the potato to the user. The electronic device 100 may display purchase products corresponding to the potato (A-American potato, B-British potato, and C-Australian potato) based on the user input data (“potato”) and the language information (English).

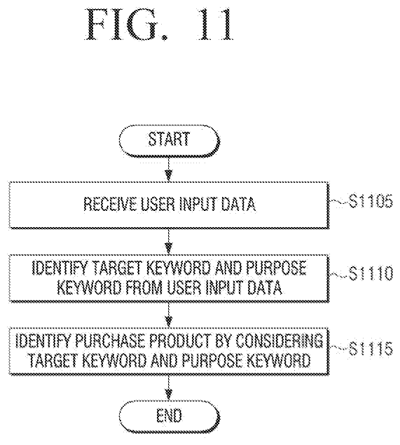

FIG. 11 is a flowchart illustrating a method for identifying a purchase product based on a target keyword and a purpose keyword according to an embodiment.

Referring to FIG. 11, the electronic device 100 may receive user input data (S1105). The electronic device 100 may identify a target keyword and a purpose keyword from the user input data (S1110). Specifically, the electronic device 100 may convert the user input data into text data, and identify the target keyword and the purpose keyword from the converted text data.

Here, the target keyword may refer to a keyword related to the purchase product. The purpose keyword may refer to a keyword related to an action corresponding to the purchase product. For example, the target keyword may be “curry” and the purpose keyword may be “ingredients”. The purpose keyword may refer to a pre-stored word, and may include at least one of ingredients, preparation, materials, cooking, cooking ingredients, a recipe, cleaning, cleaning equipment, and a cleaning method.

The electronic device 100 may identify a purchase product based on the target keyword and the purpose keyword (S1115). According to another embodiment, the electronic device 100 may identify the purchase product based on only the purpose keyword. In this case, there may be a large number of purchase products obtained as a result value, because the target is not specified. In this case, if the result value is equal to or more than a threshold value, the electronic device 100 may provide a UI for guiding the input corresponding to the target keyword to the user. When the input corresponding to the target keyword is received from the user, the electronic device 100 may identify the purchase product based on the target keyword and the purpose keyword.

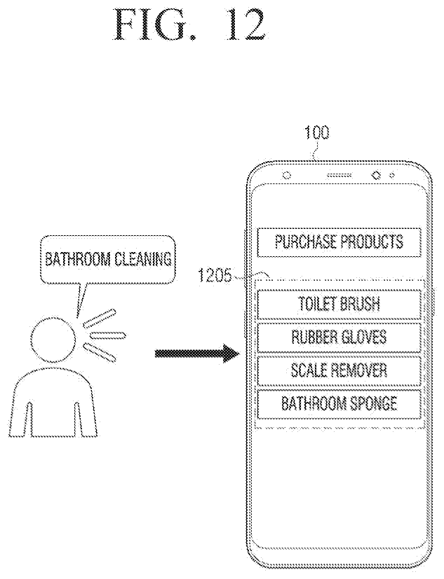

FIG. 12 is a diagram illustrating an embodiment of FIG. 11.

Referring to FIG. 12, it is assumed that the electronic device 100 receives a text “bathroom cleaning” based on user input data. The electronic device 100 may identify a target keyword and a purpose keyword from the user input data (“bathroom cleaning”). Since the target keyword and the purpose keyword may be words pre-stored in the memory 110, the electronic device 100 may determine which keywords the words (“bathroom” and “cleaning”) included in the user input data correspond to. Finally, the electronic device 100 may obtain a target keyword (“bathroom”) and a purpose keyword (“cleaning”) from the user input data (bathroom cleaning”).

The electronic device 100 may identify a plurality of products necessary to clean the bathroom based on the target keyword (“bathroom”) and the purpose keyword (“cleaning”). The plurality of products necessary to clean the bathroom may be stored in the memory 110 in advance. The electronic device 100 may provide information on the plurality of products necessary to clean the bathroom (“toilet brush, rubber gloves, scale remover, bathroom sponge”) to the user through a UI 1205. Here, if the target keyword is changed, the electronic device 100 may identify the different purchase product, although the purpose keyword is the same. Accordingly, if at least one of the target keyword or the purpose keyword is changed, the electronic device 100 may identify other results.

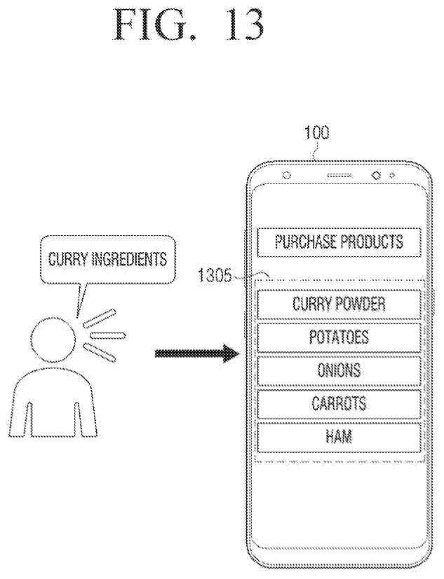

FIG. 13 is a diagram illustrating another embodiment of FIG. 11.

Referring to FIG. 13, it is assumed that the electronic device 100 receives a text “curry ingredients” based on user input data. The electronic device 100 may identify the target keyword and the purpose keyword from the user input data (“curry ingredients”). Since the target keyword and the purpose keyword are words pre-stored in the memory 110, the electronic device 100 may determine which keywords the words (“curry” and “ingredients”) included in the user input data correspond to. Finally, the electronic device 100 may obtain a target keyword (“curry”) and a purpose keyword (“ingredients”) from the user input data (“curry ingredients”).

The electronic device 100 may identify a plurality of products necessary to cook the curry (related to cooking with the curry) based on the target keyword (“curry”) and the purpose keyword (“ingredients”). The electronic device 100 may provide information on a plurality of products necessary to cook the curry (“curry powder, potatoes, onions, carrots, and ham”) to the user through a UI 1305.

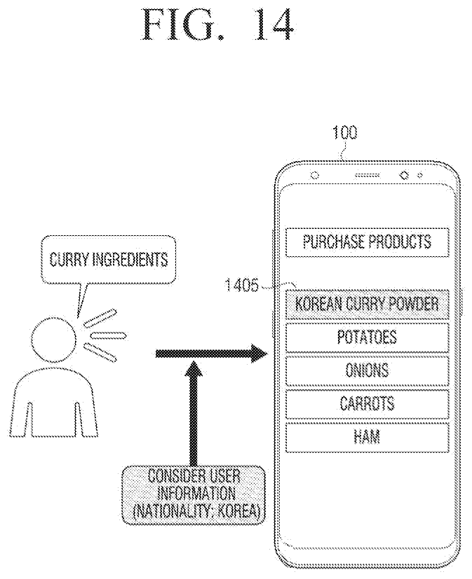

FIG. 14 is a diagram illustrating an embodiment of identifying a purchase product by considering user information.

Referring to FIG. 14, the electronic device 100 may additionally consider the user information in the embodiment of FIG. 13. Here, the information related to the user may include at least one of nationality, age, gender, purchase history, or preferred seller information of the user. In an embodiment of FIG. 14, it is assumed that the information related to the user indicates Korean nationality.

According to an embodiment, the electronic device 100 may identify the purchase product by considering all of the target keyword (“curry”), the purpose keyword (“ingredients”), and the information related to the user (“Korean nationality”). As a result, the electronic device 100 may provide “Korean curry powder, potatoes, onions, carrots, and ham” as the result of the purpose product to the user through a UI 1405.

According to another embodiment, the electronic device 100 may identify the plurality of products necessary to cook the curry (“curry powder, potatoes, onions, carrots, and ham”) based on the target keyword (“curry”) and the purpose keyword (“ingredients”). Here, as the purchase products for the curry powder, all of “Korean curry powder”, “Indian curry powder”, and “Japanese curry powder” are identified. The electronic device 100 may exclude “Indian curry powder” and “Japanese curry powder” from the search result by considering the information related to the user (“Korean nationality”), and provide only the information on the “Korean curry powder” to the user. As a result, the electronic device 100 may provide “Korean curry powder, potatoes, onions, carrots, and ham” as the purchase product result to the user through the UI 1405.

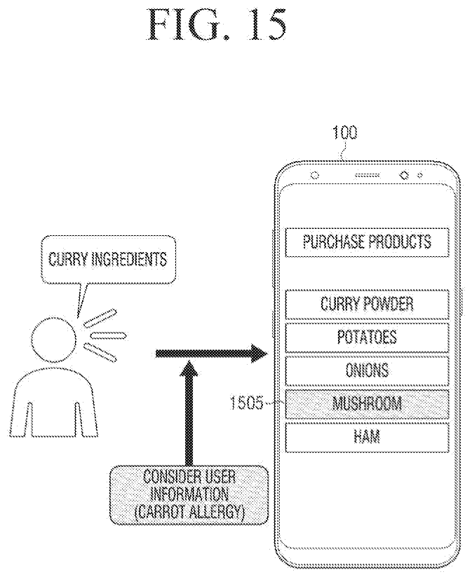

FIG. 15 is a diagram illustrating another embodiment of identifying a purchase product by considering user information.

Referring to FIG. 15, the electronic device 100 may identify purchase products by considering the allergy information from the user information. If the user is allergic to a specific food, the electronic device may guide not to purchase the corresponding food. When the user inputs the allergy information, the electronic device 100 may guide not to purchase the purchase product corresponding to the allergy information.

According to an embodiment, the electronic device 100 may automatically replace the purchase product (“carrots”) corresponding to the allergy information (“carrot allergy”) and provide information on a purchase product through a UI 1505. For example, when the obtained purchase product includes the purchase product (“carrots”) corresponding to the carrot allergy information, the electronic device 100 may provide a purchase product (“mushroom”) capable of being replaced with the purchase product (“carrot”) corresponding to the allergy information to the user.

According to another embodiment, the electronic device 100 may provide a separate confirmation UI showing that the purchase product (“carrot”) corresponding to the allergy information (“carrot allergy”) will be replaced.

As a result, the electronic device 100 may identify purchase products (“curry powder, potatoes, onions, carrots, and ham”) by considering the target keyword (“curry”) and the purpose keyword (“ingredients”). If the identified purchase products (“curry powder, potatoes, onions, carrots, and ham”) include the purchase product (“carrots”) corresponding to the information related to the user (“carrot allergy”), the electronic device 100 may change the purchase product (“carrots”) to other replacement product (“mushroom”).

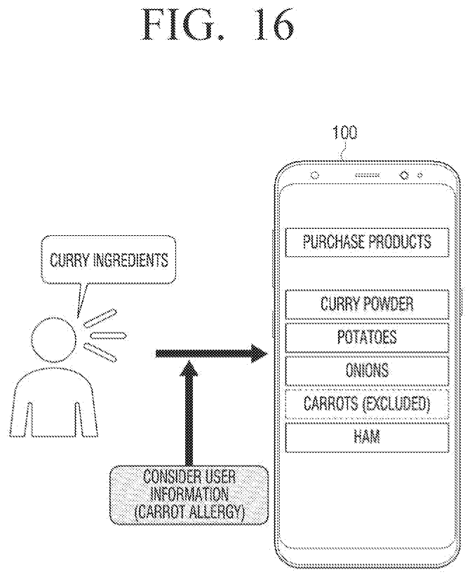

FIG. 16 is a diagram illustrating still another embodiment of identifying a purchase product by considering user information.

Referring to FIG. 16, the electronic device 100 may identify the purchase products (“curry powder, potatoes, onions, carrots, and ham”) by considering the target keyword (“curry”) and the purpose keyword (“ingredients”). If the identified purchase products (“curry powder, potatoes, onions, carrots, and ham”) include the purchase product (“carrots”) corresponding to the information related to the user (“carrot allergy”), the electronic device 100 may exclude the purchase product (“carrots”).

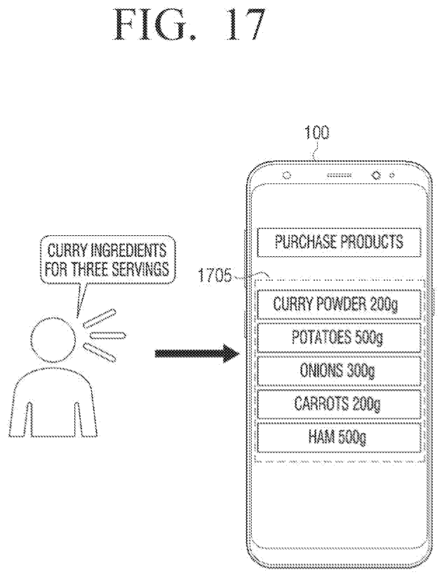

FIG. 17 is a diagram illustrating an embodiment of identifying a purchase product by considering various keywords.

Referring to FIG. 17, the electronic device 100 may obtain an amount keyword from the user input data. The electronic device 100 may determine a number of purchase products or a volume of the purchase product based on the amount keyword. For example, when the user input data (“curry ingredients for three servings”) is received, the electronic device 100 may identify the target keyword (“curry”), the purpose keyword (“ingredients”), and the amount keyword (“three servings”). The electronic device 100 may identify the purchase products based on the target keyword (“curry”) and the purpose keyword (“ingredients”), and determine the number or volume of the identified purchase product based on the amount keyword (“three servings”). For example, the electronic device 100 may provide a UI 1705 showing that the curry ingredients for three servings are curry powder (200 g), potatoes (500 g), onions (500 g), carrots (200 g), and ham (500 g) to the user. If the information corresponding to the amount keyword refers to a larger amount, the number or volume of the purchase products may increase. For example, if the user input data is “curry ingredients for six servings”, the electronic device 100 may provide the UI 1705 showing that the curry ingredients for six servings are curry powder (400 g), potatoes (1000 g), onions (600 g), carrots (400 g), and ham (1000 g) to the user.

FIG. 18 is a diagram illustrating an operation of calculating a weight limit by using weight information according to an embodiment.

Referring to FIG. 18, the electronic device 100 may obtain weight information on each of the purchase products and obtain total weight information of the purchase products. For example, if the electronic device 100 obtains rice (30 kg), water (10 kg), TV (20 kg), oranges (10 kg), and beer (30 kg), the total weight may be 100 kg.

Here, the electronic device 100 may obtain weight limit information of the user. The weight limit of the user may refer to information indicating up to which weight at least one person is able to carry. For example, a weight limit of the grown man may be preset as 30 kg and a weight limit of the grown woman may be preset as 10 kg.

The electronic device 100 may compare the weight limit information of the user and total weight information of purchase products. If the total weight information of purchase products is greater than the weight limit information of the user, the electronic device 100 may exclude at least one of the purchase products.

If it is assumed that the number of grown men who can carry the products is three, the user weight information may be 90 kg. The information on three grown men 1801, 1802, and 1803 may be received by the input of the user after confirming the purchase products or generating the purchase product list. If the total weight information of purchase products (“100 kg”) is greater than the weight limit information of the user (“90 kg”), the electronic device 100 may exclude at least one (“water” or “oranges”) from the purchase products. Here, the electronic device 100 may provide a product that is able to be excluded (“water” or “oranges”) selectively to the user through UIs 1810 and 1820 by considering a difference value (“10 kg”) between the total weight information of purchase products (“100 kg”) and the weight limit information of the user (“90 kg”). If the product that is able to be excluded is input from the user, the electronic device 100 may exclude the selected product from the purchase products.

FIG. 19 is a diagram illustrating an operation of determining a packing method by using weight information according to an embodiment.

Referring to FIG. 19, the electronic device 100 may obtain the total weight information of the purchase products. If the user weight limit information is not greater than the total weight information of the purchase products, the electronic device 100 may identify a method for classifying the purchase products. When the classification method is identified, the purchase products may be equally divided, when it is necessary to directly carry the purchase products.

It is assumed that the products purchased by the user and the weights thereof are rice (30 kg), water (10 kg), TV (20 kg), and beer (30 kg). The electronic device 100 assumes that the total weight of the purchase products is 90 kg. In addition, it is assumed that the user weight limit is 90 kg based on three grown men 1901, 1902, and 1903 (weight limit per grown man: 30 kg). Here, the electronic device 100 may classify the purchase products based on the weight information of each of the purchase products. For example, the electronic device 100 may identify the purchase product corresponding to a first user 1901 as the rice (30 kg), identify the purchase product corresponding to a second user 1902 as the TV (20 kg) and water (10 kg), and identify the purchase product corresponding to a third user 1903 as beer (30 kg). The electronic device 100 may provide the purchase product corresponding to each user to the user through a UI 1905.

A method for determining which product is to be carried for each user may contribute to easy delivery of the purchase products. Because, since the weight is equally distributed for each basket, the weight thereof does not exceed the weight limit of each user. For example, if the purchase products are arbitrarily classified, 40 kg of purchase products may be included in a specific basket, and a specific user may not carry 40 kg of basket, because the weight limit of the user is 30 kg. However, when the UI 1905 regarding the classification of the purchase products described above is provided, the above problem may be solved.

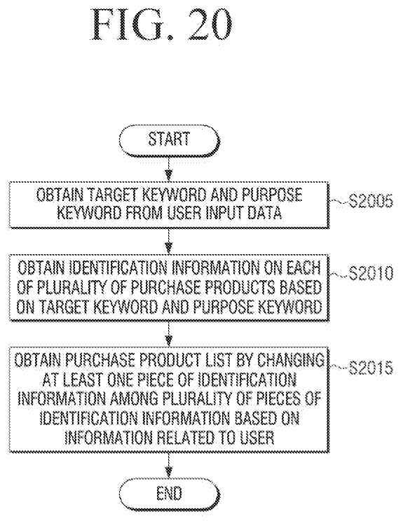

FIG. 20 is a flowchart illustrating a method for controlling the electronic device according to another embodiment.

Referring to FIG. 20, a method for controlling an electronic device storing at least one instruction according to an embodiment of the disclosure may include, by executing the at least one instruction, obtaining a target keyword and a purpose keyword from user input data (S2005).

The control method may include obtaining identification information (e.g., a plurality of pieces of identification information) on each of a plurality of purchase products based on the target keyword and the purpose keyword (S2010).

The control method may include obtaining a purchase product list by changing at least one piece of identification information among the plurality of pieces of identification information based on information related to the user (S2015).

The obtaining the purchase product list (S2015) may include obtaining the purchase product list by replacing the at least one piece of identification information among the plurality of pieces of identification information with identification information corresponding to another purchase product based on the information related to the user.

The obtaining the purchase product list (S2015) may include obtaining the purchase product list including identification information obtained by excluding the at least one piece of identification information from the plurality of pieces of identification information based on the information related to the user.

The information related to the user may include at least one of nationality, age, gender, purchase history, or preferred seller information of the user.

The obtaining the identification information (S2010) may include, based on the target keyword being a food name and the purpose keyword being a keyword related to cooking, obtaining identification information on each ingredient necessary to cook the food, the obtaining the purchase product list may include obtaining a purchase product list by changing at least one piece of identification information among the plurality of pieces of identification information based on the information related to the user, and the information related to the user may include at least one of nationality, age, gender, purchase history, preferred seller information, allergy information, or taste information of the user.

The obtaining the target keyword and the purpose keyword (S2005) may include obtaining a target keyword and a purpose keyword from the user input data by using an artificial intelligence model, and the artificial intelligence model may be trained to obtain keywords related to product purchase from input data.

The method for controlling the electronic device may further include displaying the purchase product list, changing identification information corresponding to at least one product included in the purchase product list based on a user input, and displaying a purchase product list obtained based on the changed identification information.

The user input data may include at least one of text data, image data, or voice data.

The obtaining the identification information (S2010) may include identifying a language corresponding to text information obtained from the user input data, and obtaining identification information on each of the plurality of purchase products based on the identified language.

The method for controlling the electronic device may further include determining a purchase order of each purchase product included in the purchase product list based on location information in a store of each purchase product included in the purchase product list, and changing the purchase product list based on the determined purchase order.

The method for controlling the electronic device 100 as in FIG. 20 may be executed on the electronic device having the configuration of FIG. 1 or FIG. 2, and may also be executed on an electronic device having other configuration.

The methods according to the embodiments of the disclosure described above may be implemented in a form of an application installable in the electronic device of the related art.

In addition, the methods according to the embodiments of the disclosure described above may be implemented simply by the software upgrade or hardware upgrade in the electronic device of the related art.

Further, the embodiments of the disclosure described above may be performed through an embedded server provided in the electronic device or at least one external server of an electronic device and a display device.

According to an embodiment of the disclosure, various embodiments of the disclosure may be implemented as software including instructions stored in machine (e.g., computer)-readable storage media. The machine is a device which invokes instructions stored in the storage medium and is operated according to the invoked instructions, and may include an electronic device (e.g., electronic device A) according to the disclosed embodiments. In a case where the instruction is executed by a processor, the processor may perform a function corresponding to the instruction directly or using other elements under the control of the processor. The instruction may include a code made by a compiler or a code executable by an interpreter. The machine-readable storage medium may be provided in a form of a non-transitory storage medium. Here, the “non-transitory” storage medium is tangible and may not include signals, and it does not distinguish that data is semi-permanently or temporarily stored in the storage medium.

According to an embodiment of the disclosure, the methods according to various embodiments disclosed in this disclosure may be provided in a computer program product. The computer program product may be exchanged between a seller and a purchaser as a commercially available product. The computer program product may be distributed in the form of a machine-readable storage medium (e.g., compact disc read only memory (CD-ROM)) or distributed online through an application store (e.g., PlayStore™). In a case of the on-line distribution, at least a part of the computer program product may be at least temporarily stored or temporarily generated in a storage medium such as a memory of a server of a manufacturer, a server of an application store, or a relay server.

Each of the elements (e.g., a module or a program) according to various embodiments described above may include a single entity or a plurality of entities, and some sub-elements of the abovementioned sub-elements may be omitted or other sub-elements may be further included in various embodiments. Alternatively or additionally, some elements (e.g., modules or programs) may be integrated into one entity to perform the same or similar functions performed by each respective element prior to the integration. Operations performed by a module, a program, or other elements, in accordance with various embodiments, may be performed sequentially, in a parallel, repetitive, or heuristically manner, or at least some operations may be performed in a different order, omitted, or may add a different operation.

While certain embodiments of the disclosure have been shown and described, the disclosure is not limited to the aforementioned specific embodiments, and it is apparent that various modifications can be made by those having ordinary skill in the technical field to which the disclosure belongs, without departing from the spirit of the disclosure as claimed by the appended claims. Also, it is intended that such modifications are not to be interpreted independently from the technical idea or prospect of the disclosure.

What is claimed is:

1. An electronic device comprising:
a memory storing at least one instruction; and
a processor configured to execute the at least one instruction to:
obtain a target keyword and a purpose keyword from user input data;
obtain a plurality of pieces of identification information on each of a plurality of purchase products based on the target keyword and the purpose keyword; and
obtain a purchase product list by changing at least one piece of identification information among the plurality of pieces of identification information based on information related to a user.

2. The electronic device according to claim 1, wherein the processor is further configured to execute the at least one instruction to obtain the purchase product list by replacing the at least one piece of identification information among the plurality of pieces of identification information with identification information corresponding to another purchase product based on the information related to the user.

3. The electronic device according to claim 1, wherein the processor is further configured to execute the at least one instruction to obtain the purchase product list comprising identification information obtained by excluding the at least one piece of identification information from the plurality of pieces of identification information based on the information related to the user.

4. The electronic device according to claim 1, wherein the information related to the user comprises at least one of nationality, age, gender, purchase history, or preferred seller information of the user.

5. The electronic device according to claim 1, wherein the processor is further configured to execute the at least one instruction to:
based on the target keyword being a name of a food and the purpose keyword being a keyword related to cooking, obtain identification information on at least one ingredient related to cooking the food; and
obtain a changed purchase product list by changing at least one piece of identification information among the obtained identification information on the at least one ingredient based on the information related to the user, and
wherein the information related to the user comprises at least one of nationality, age, gender, purchase history, preferred seller information, allergy information, or taste information of the user.

6. The electronic device according to claim 1, wherein the processor is further configured to execute the at least one instruction to obtain the target keyword and the purpose keyword from the user input data by using an artificial intelligence model, and
wherein the artificial intelligence model is trained to obtain keywords related to a product purchase from input data.

7. The electronic device according to claim 1, further comprising:
a display,
wherein the processor is further configured to execute the at least one instruction to:
control the display to display the purchase product list;
change identification information corresponding to at least one product included in the purchase product list based on the user input data; and
control the display to display a changed purchase product list obtained based on the changed identification information.

8. The electronic device according to claim 1, wherein the user input data comprises at least one of text data, image data, or voice data.

9. The electronic device according to claim 8, wherein the processor is further configured to execute the at least one instruction to:
identify a language corresponding to text information obtained from the user input data; and
obtain the plurality of pieces of identification information on each of the plurality of purchase products based on the identified language.

10. The electronic device according to claim 1, wherein the processor is further configured to execute the at least one instruction to:
determine a purchase order of each purchase product included in the purchase product list based on location information in a store of each purchase product included in the purchase product list; and
change the purchase product list based on the determined purchase order.

11. A method for controlling an electronic device storing at least one instruction, the method comprising:
obtaining a target keyword and a purpose keyword from user input data;
obtaining a plurality of pieces of identification information on each of a plurality of purchase products based on the target keyword and the purpose keyword; and
obtaining a purchase product list by changing at least one piece of identification information among the plurality of pieces of identification information based on information related to a user.

12. The method according to claim 11, wherein the obtaining the purchase product list comprises obtaining the purchase product list by replacing the at least one piece of identification information among the plurality of pieces of identification information with identification information corresponding to another purchase product based on the information related to the user.

13. The method according to claim 11, wherein the obtaining the purchase product list comprises obtaining the purchase product list comprising identification information obtained by excluding the at least one piece of identification information from the plurality of pieces of identification information based on the information related to the user.

14. The method according to claim 11, wherein the information related to the user comprises at least one of nationality, age, gender, purchase history, or preferred seller information of the user.

15. The method according to claim 11, wherein the obtaining the plurality of pieces of identification information comprises, based on the target keyword being a name of a food and the purpose keyword being a keyword related to cooking, obtaining identification information on at least one ingredient related to cooking the food,
wherein the obtaining the purchase product list comprises obtaining a changed purchase product list by changing at least one piece of identification information among the obtained identification information on the at least one ingredient based on the information related to the user, and
wherein the information related to the user comprises at least one of nationality, age, gender, purchase history, preferred seller information, allergy information, or taste information of the user.
